(19) United States
(12) Patent Application Publication
(10) Pub. No.: US 2007/0080578 A1
(43) Pub. Date: Apr. 12, 2007

(54) Image controlled lighted hubcaps

(76) Inventors: David Groomes, Dayton, OH (US); Michael L. Wright, Dayton, OH (US)

Correspondence Address: William M. Selenke, 5 Drummond St., Cincinnati, OH, 45218, US

(21) Appl. No.: 11/245,405

(22) Filed: Oct. 6, 2005

(51) Int. Cl. B60B 27/00

(52) U.S. Cl. 301/105.1

(57) ABSTRACT

The invention is a system to produce lighted patterns on hubcaps which lighted patterns correspond analogically to sound. Such sound sources are a radio, a CD player, a tape player, a DVD player, or a microphone. A transfer means, either wired or wireless, receive electronic impulses that represent sounds from music source. That transfer means carries the electronic impulses that corresponds analogically to sound to a color transformation device which control the various types of lights. The signals that control the various types of lights are transported either by wire or wireless to a receiver inside hubcaps or to a receiver which is external to the hubcaps. Such an external receiver light source projects various color sequences onto hubcaps. The light source controlled by receiver internal to the hub cap transfers such light by fiber optics or refractory (fresnal lens) materials to the surface of the hubcap. Likewise, the source of the light for the hubcaps may be a projector that focuses on outer surface of the hubcap. The special hubcaps can be attached and rotate at the same rate as the wheel, or may be free-wheeling type hubcaps. In an alternative embodiment of the invention the lights projected may be pictures from a camera or a DVD which pictures project onto the hubcaps. The external projector may be permanently attached or may be removable.

### FIELD OF INVENTION

The present invention is concerned with novelty hubcaps for automobiles and such. More specifically the invention is considered with lighted hubcaps wherein variegated light placed on such hubcaps is controlled with color and intensity by sounds or music.

### BACKGROUND OF INVENTION

Various subsets of American population are greatly concerned with automobiles and automobile appearance. A decorative feature of automobiles is their hubcaps. Fancy hubcaps may be factory original or purchased and installed as aftermarket items. Novelty hubcaps seem to have a special appeal. Perhaps the most common of the novelty hubcaps are hubcaps that spin independently of the power and motion of the automobile's wheels and tires. That is with the automobile speeds up the hubcaps have retarded spinning motion. However when the car slows, the hubcaps continue to spin independently of the decreased motion of the automobile tires. These kinds of spinning hubcaps are relatively common.

For decades it has been common for young men to promenade in their cars on certain streets. They show off their cars and themselves to their peers and other interested parties. If this “dragging” is the in the dark for the lighted hubcaps would be useful decorative items for the automobiles. For this reason, there is a considerable body of patented art concerning lighted hubcaps. See for example: U.S. Pat. No. 5,497,302 Lighted Hubcap, U.S. Pat. No. 6,644,839 Lighted Wheel Rim System.

Likewise, in certain ethnic groups it is socially prestigious to play loud music from the automobile sound system. The purpose of the present invention is to combine these two customs. That is to combine the music or voice which can be from a microphone, a radio, a CD, a DVD, tape, or MP3 player that is controlled by the driver or passenger of the concerned automobile. This music or voice can be converted into electronically controlled color commentary that originates in the automobile sound system. This sound is converted into color patterns that can be displayed upon automobile hubcaps.

It is to be noted that the environment where the rubber meets the road is dirty and can be often wet from rain and snow. Needless to say, in wintry climate the effects of salt on the undersurface of automobiles and in wheel wells would be quite harmful to electronic and optical gear. For this reason one of the embodiments of the present invention is that the receiver-projector elements may be crafted so that the projector elements can be removed. Likewise, this invention, called Vision Rims™ may be used for advertising. Realtors and/or other business individuals may use pictures or picture/sound devices such as DVDs as sources of illustrations to project motion or still pictures on hubcaps in lieu of advertising placards affixed to their vehicles.

### SUMMERY OF INVENTION

The invention is a system to produce lighted patterns on hubcaps which lighted patterns correspond analogically to sound. Such sound sources are a radio, a CD player, a tape player, a DVD player, a microphone, or other sources that emanates sound. A transfer means, either wired or wireless, receive electronic impulses that represent sounds from a music source. That transfer means carries the electronic impulses that corresponds analogically to sound to a color transformation device which control the various types of lights. The signals that control the various types of lights are transported either by wire or wireless to a receiver inside hubcaps or to a receiver which is external to the hubcaps. Such an external receiver light source projects various color sequences onto hubcaps. The light source controlled by receiver internal to the hub cap transfers such light by fiber optics or fresnal lens materials to the surface of the hubcap. Likewise, the source of the light for the hubcaps may be a projector that focuses on outer surface of the hubcap. The special hubcaps can be attached and rotate at the same rate as the wheel, or may be free-wheeling type hubcaps. In an alternative embodiment of the invention the lights projected may be motion or still pictures from a camera, DVD or other photographic sources which pictures project onto the hubcaps. The external projector may be permanently attached or may be removable. The invention includes light source projector picture sound devices such as DVDs to project motion or still pictures on hubcaps in lieu of advertising placards affixed to their vehicles.

### BRIEF DESCRIPTION OF THE FIGURES

FIG. 1 is a diagram of the system FIG. 2 shows a cutoff view of workpiece automobile to illustrate the placement of the invention. FIG. 3 shows a hubcap with special reflective hubcap surface. FIG. 4 illustrates certain modifications of hubcaps for alternative embodiments of the invention. FIG. 5 shows a cutoff view of workpiece automobile in an embodiment that uses DVD pictures as the source of projected color. FIG. 6 shows that certain embodiments of the present invention may be removed to prevent deterioration caused by harsh road conditions such as weather. The present invention may be used to project advertising sequences whether still or motion pictures from DVDs onto the rim and hubcaps

### DETAILED DESCRIPTION OF THE FIGURES

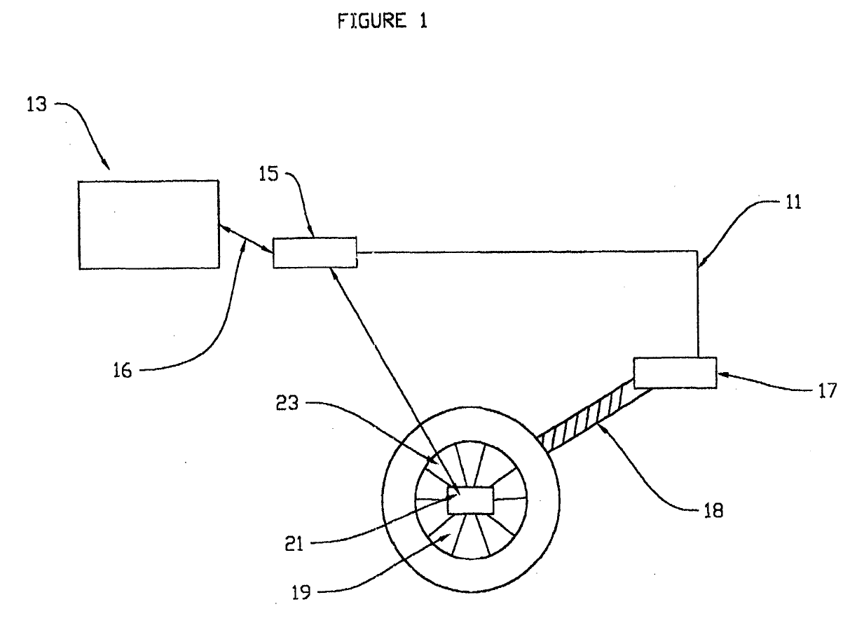

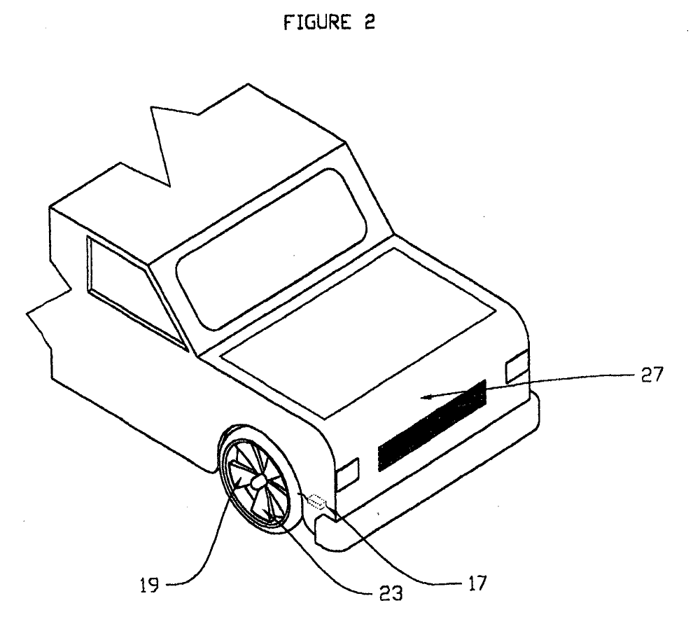

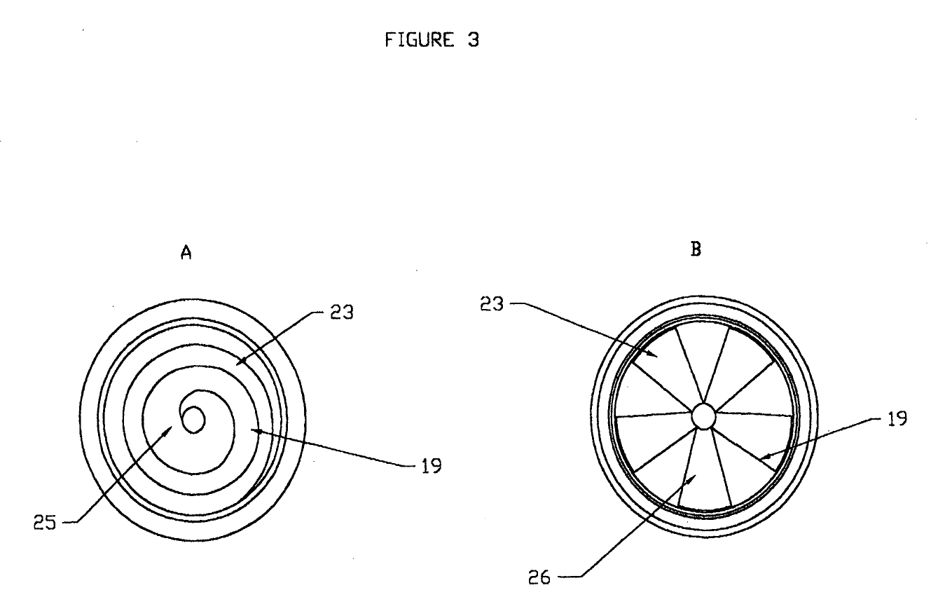

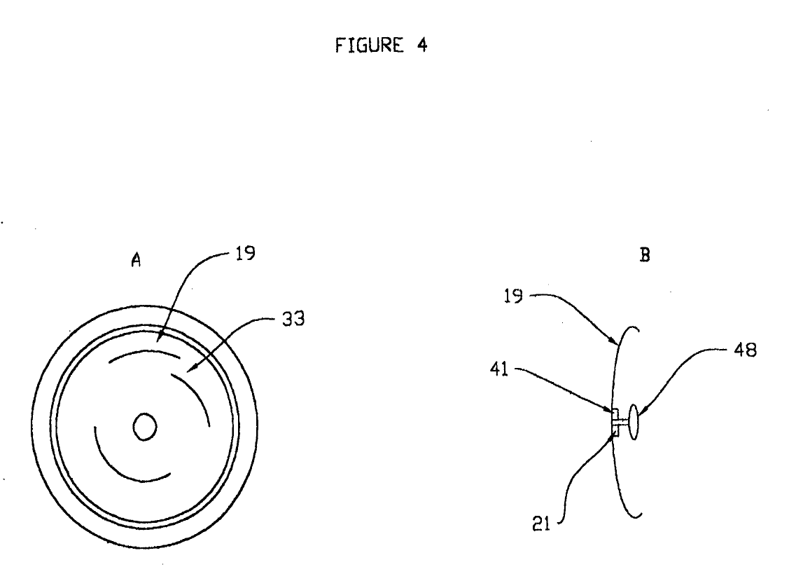

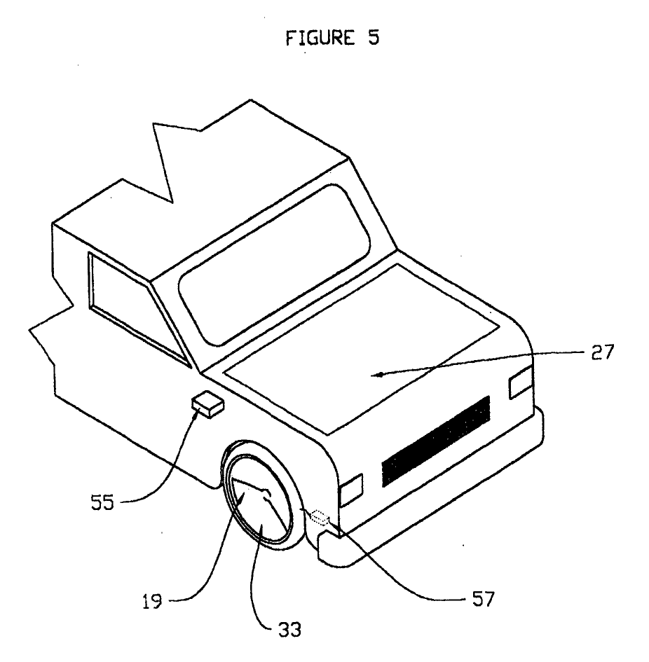

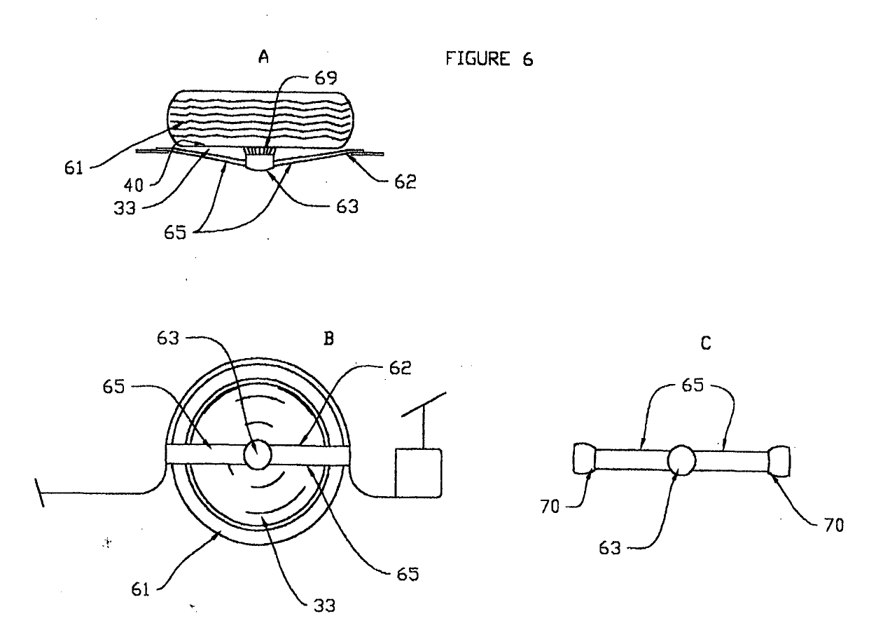

FIG. 1 is a diagram that shows the system 11. The system 11 comprises a sound music source 13. Sources for the music or sound 13 may be a radio, a CD player, a DVD player, a tape player, a M3P player or a microphone for voice projection from the driver or passenger. The electronic impulses that represent sounds from music source 13 are transferred 16 to a sound to color transformation device 15. Sound to color transformation devices 15 are standard off-the-shelf electronic devices. These electronically transformed sounds are transferred into signals that control the various types of lights. These electronic signals which encode light are transferred to light source 17. Light source 17 projects various color sequences 18 onto hubcaps 19. In a second embodiment, the sounds transformed electronically in the signals are transferred wirelessly to a receiver 21 in hubcaps 19. Receiver 21 in hubcaps 19 transfers the colors to the outer surface 23. This sound from music source 13 is reflected in colors on the hubcap 19. Note the hubcap 19 can be attached and rotate at the same rate as the wheel, or may be free-wheeling. Of course, such colors may be projected onto one or more hubcaps.

FIG. 2 shows a cutoff view of workpiece automobile 27. Shown is hubcap 19. Hubcap 19 is covered with surfaces 23 that reflect and transform light. This can include phosphors that react to specific wavelengths. Light source 17 projects various color sequences onto hubcaps 19 with surfaces 23 that reflect and transform light.

FIG. 3 shows hubcap 19 with hubcaps surface 23. Hubcap A shows that the color reaction surface 23 is covered with a spiral pattern 25. Hubcap B shows a radial pattern 26 for surface 23.

FIG. 4 A shows a head on view of hubcap 19 which has a special flat surface 33 to accurately reflect the project light whether abstract or realistic as in FIG. 5. In this embodiment the hubcap has an internal receiver 21 for sounds transformed electronically which sounds encode for light. Internal receiver 21 creates and transfers various color sequences 18 onto hubcaps 19. In a second embodiment, the sounds transformed electronically in the signals are transferred wirelessly to a receiver 21 in hubcap 19. These colors are projected by various means such as reflective surfaces or fiber optics onto the hubcap surface 41 to produce colors that correspond analogously to the sounds produced by source for the music, or sound 13. FIG. 4B shows an inertial generator 48 for the electricity required to produce colors Electricity may be supplied by a battery.

FIG. 5 shows a cutoff view of workpiece automobile 27. A transfer means to transfer the picture from the DVD player 55 to a projector 57. Shown is hubcap 19. Hubcap 19 is covered with a special flat surface 33 that reflects light. Projector 57 projects images from a DVD player 55 onto hubcap 19 flat surface 33. Thus by playing a DVD the operator of the automobile can project various images onto the respective hubcap 19 flat surface 33.

Because of the harsh environment that is present within the wheel well in more severe climate the sound to light projector device may need to be removed and temporarily stored as in a further embodiment. FIG. 6 shows three views of an alternative embodiment 62 of the present invention. 6A shows a top view of a tire 61 with reflective hubcap surface 33. Receiver-projector 63 is supported by braces 65, which may be made of a clear plastic. Light rays 69 are shown being focused from receiver-projector 63 unto reflective hubcap surface 33. Receiver-projector 63 may be powered either by batteries or by plug in wiring to receive electricity from the car's battery. FIG. 6B shows the side view of this alternative embodiment. Tire 61 has reflective hubcap surface 33. Receiver-projector 63 is supported by braces 65, which may be made of a clear plastic. FIG. 6C is shows receiver-projector 63 in isolation. Reversible attachment means 70 at each end of support braces 65 holds receiver-projector 63. Reversible attachment means 70 affixed alternative embodiment 62 to rim of body edge of car wheel well.

We claim:

1) A system to produce lighted patterns on hubcaps that corresponds analogically to sound comprising:
a source for the sound;
a transfer means for electronic impulses that represent sounds from music source;
said transfer means carries said electronic impetuses that corresponds analogically to sound to a color transformation device;
transformed electronically sounds are transferred into signals that control the various types of lights;
said signals are transported either by wire or wireless to a light source;
light source projects various color sequences onto hubcaps.

2) A system to produce lighted patterns on hubcaps that corresponds analogically to sound as in claim 1) wherein said source for sound may be a radio, a CD player, a tape player, a DVD player, an MP3 player, or a microphone.

3) A system to produce lighted patterns on hubcaps that corresponds analogically to sound as in claim 1) wherein said light source is external to the hubcaps.

4) A system to produce lighted patterns on hubcaps that corresponds to sound as in claim 1) wherein said sounds transformed electronically in the signals are transferred wirelessly to a receiver inside hubcaps;
said receiver inside hubcap transfers the colors to the outer surface of said hubcap.
said sound source is reflected in analogy into colors on the hubcap flat surface.

5) A system to produce lighted patterns on hubcaps that corresponds to sound as in claim 4) wherein said hubcaps can be affixed to the wheel, or may be free-wheeling.

6) A system to produce lighted patterns on hubcaps that corresponds to sound comprising;
a DVD player;
a transfer means to transfer the picture from the DVD to a projector;
said projector projects the DVD picture on one or more flat hubcaps of the respective car.

7) A system to produce lighted patterns on hubcaps that corresponds analogically to sound as in claim 6) wherein said light source projector that projects various color sequences onto hubcaps is supported by braces;
said braces are attached to wheel wells by reversible attachment means.

8) A system to produce lighted patterns on hubcaps that corresponds analogically to sound as in claim 6) wherein said light source projector that projects various advertising sequences onto hubcaps is supported by braces;
said braces are attached to wheel wells by reversible attachment means.

9) A system to produce lighted patterns on hubcaps that corresponds analogically to sound as in claim 6) wherein said light source projector picture sound devices such as DVDs to project motion or still pictures on hubcaps in lieu of advertising placards affixed to their vehicles.
